(19) United States
(12) Patent Application Publication
(10) Pub. No.: US 2023/0154217 A1
(43) Pub. Date: May 18, 2023

(54) Method for Recognizing Text, Apparatus and Terminal Device

(71) Applicant: TP-Link Corporation Limited, Hong Kong (CN)

(72) Inventor: Dizhen HUANG, Shenzhen (CN)

(21) Appl. No.: 17/987,862

(22) Filed: Nov. 16, 2022

(30) Foreign Application Priority Data
Nov. 16, 2021 (CN) 202111354701.1

(51) Int. Cl. G06V 30/19; G06V 30/18; G06V 30/162; G06V 30/14

(52) U.S. Cl. CPC G06V 30/19173; G06V 30/19147; G06V 30/1916; G06V 30/18076; G06V 30/162; G06V 30/1452; G06V 10/82

(57) ABSTRACT

The present disclosure discloses a method for recognizing text, an apparatus and a terminal device. The method for recognizing text includes: acquiring a sample text dataset, preprocessing text image in the sample text dataset, and generating a label image; inputting the label image into a text recognition model for training, extracting image features, performing down-sampling, restoring an image resolution, normalizing an output probability for the last layer using a sigmoid layer to output a multiple prediction maps with different scales, and optimizing a loss function of the text recognition model to obtain a trained text recognition model; preprocessing a text image to be recognized, inputting the text image to be recognized which is preprocessed into the trained text recognition model, and outputting a clear-scale prediction map; and analyzing the clear-scale prediction map to obtain a text sequence of the text image to be recognized.

### CROSS-REFERENCE TO RELATED APPLICATION

The present disclosure claims the priority of Chinese Patent Application No. 202111354701.1, filed on Nov. 16, 2021, and entitled “Method for Recognizing Text and Apparatus, Terminal Device and Storage Medium”, which is appended herein by reference in its entirety.

### TECHNICAL FIELD

The present disclosure relates to the technical field of image processing, and particularly relates to a method for recognizing text, an apparatus and a terminal device.

### BACKGROUND

Text recognition is based on digital image processing, pattern recognition, computer vision and other technologies. A text sequence in an image is read by using an optical technology and a computer technology, and is converted into a format that can be accepted by computers and understood by people. Text recognition is widely used in daily life, and is applied to following scenarios: recognition of business cards, recognition of menus, recognition of express waybills, recognition of identity cards, recognition of business registration certificates, recognition of bank cards, recognition of license plates, recognition of street nameplates, recognition of commodity packaging bags, recognition of conference white boards, recognition of advertising keywords, recognition of test paper, recognition of receipts, etc.

A traditional method for recognizing text generally includes: image preprocessing, text region positioning, text character segmentation, text recognition, text post-processing and other steps. The processes are cumbersome, and the effect of each step will affect the effects of the following steps. At the same time, in the traditional method, some complex preprocessing measures are required to ensure a text recognition effect in the case of non-uniform lighting, fuzzy images, etc., and the computation amount is large. The text recognition process of a deep learning method still includes the steps of text region positioning and text recognition. The process is cumbersome, and two neural networks need to be trained to achieve a final recognition effect, and the computation amount is large.

### SUMMARY

Some embodiments of the present disclosure provide a method for recognizing text and an apparatus, a terminal device and a storage medium. The method includes:

a sample text dataset is acquired, and each text image in the sample text dataset is preprocessed, and the sample text dataset including a text position, positions of various characters in a text, and a character category;

a label image is generated according to the text image which is preprocessed, the label image including a text region, a text boundary region, a character region, a character boundary region, and the character category, and diffusion annotation is performed on the text boundary region and the character boundary region;

the label image is input into the text recognition model for training; image features are extracted using a convolution layer; down-sampling is performed using a pooling layer; an image resolution is restored using up-sampling layer or a deconvolution layer; an output probability is normalized for the last layer using a sigmoid layer to output a multiple prediction maps with different scales; a loss function of the text recognition model is optimized using an optimizer to obtain a trained text recognition model;

a text image to be recognized is preprocessed and is input into the trained text recognition model, and the trained text recognition model outputs a clear-scale prediction map; and

the clear-scale prediction map is analyzed to obtain a text sequence of the text image to be recognized.

Optionally, the diffusion annotation performed on the text boundary region and the character boundary region specifically includes:

m(x,y) is set as a boundary point, wherein for any point p(x, y), there is a boundary point

$$q = {arg min}_{m} {‖ m - p ‖}_{2}$$

closest to point p, and an annotation formula is:

$$f ( p ) = \{ \begin{matrix}\begin{matrix}{v}_{max} , & {‖ p - q ‖}_{2} = 0 \\ 0 , & {‖ p - q ‖}_{2} > T\end{matrix} \\ {v}_{max} - \frac{{v}_{max} - {v}_{min}}{T} {‖ p - q ‖}_{2} , 0 < {‖ p - q ‖}_{2} \leq T\end{matrix} ;$$

And T is a distance threshold; vₘₐₓ and vₘᵢₙ represent set empirical values; a label value of a pixel point located in the center of the boundary is the vₘₐₓ; and a label value of a pixel point located around the boundary is between the vₘᵢₙ and the vₘₐₓ.

Optionally, the multiple prediction maps with different scales includes a clear-scale prediction map and a fuzzy-scale prediction map; the clear-scale prediction map includes a text region, a text boundary region, a character region, a character boundary region and a character category, and the fuzzy-scale prediction map comprises a text region, a text character region and a character category.

Optionally, the loss function of the text recognition model includes a loss of the text region, a loss of the character region and a loss of the character category, and

the loss of the text region includes loss of a text main region and loss of the text boundary region, that is:

L_{c}=λₚLₚ+λ_{pb}L_{pb};

and Lₐ is total loss of the text region; Lₚ is cross entropy loss of the text region; L_{pb} is cross entropy loss of the text boundary region; λₚ is the weight of the loss of the text main region, λ_{pb} is the weight of the loss of the text boundary region;

the loss of the character region includes loss of a character main region and loss of the character boundary region, that is:

L_{b}=λ_{ch}L_{ch}+λ_{chb}L_{chb};

and L_{b} is total loss of the character region; L_{ch} is cross entropy loss of the character main region; L_{chb} is cross entropy loss of the character boundary region; λ_{ch} is the weight of the loss of the character main region, λ_{chb} is the weight of the loss of the character boundary region;

the loss of the character category is: L_{c}=L_{cls};

the loss function of the text recognition model is L=λₐLₐ+λ_{b}L_{b}+λ_{c}L_{c}, and λₐ is the weight of the total loss of the text region, λ_{b}, is the weight of the total loss of the character region λ_{c} is the weight of the loss of the character category.

Optionally, the clear-scale prediction map is analyzed to obtain a text sequence of the text image to be recognized includes:

a text box is analyzed according to a text region prediction map and a text boundary region prediction map to obtain the text region;

a character box in the text region is analyzed according to a character region prediction map and a character boundary prediction map to obtain the character region;

the character category with the highest probability in the character region is taken as a category of a pixel point, and counting the character category with the largest number of pixel points as a final character category of the character box; and

characters are connected according to the positions of the characters to obtain a text sequence of the text image to be recognized.

Optionally, the text box is analyzed according to the text region prediction map and the text boundary region prediction map to obtain the text region specifically includes:

the text box is analyzed according to the text region prediction map and the text boundary region prediction map, pixel points that satisfy ω₁p₁+ω₂p₂>T are set to 1, and a first binary image is obtained, where ω₁ and ω₂ are both set weights; p₁∈[0,1] is a text region prediction probability; p₂∈[0,1] is a text boundary region prediction probability; T∈[0,1] is a set threshold;

neighborhood connection is performed on the pixel points whose pixel values are 1 in the first binary image to obtain a plurality of connection units, and selecting a minimum bounding rectangle of the connection unit with the largest area as the text region.

Optionally, the character box in the text region is analyzed according to the character region prediction map and the character boundary prediction map to obtain the character region includes:

the character box in the text region is analyzed according to the character region prediction map and the character boundary region prediction map, setting pixel points that satisfy ω₃p₃+ω₄p₄>T to 1, and obtaining a second binary image, where ω₃ and ω₄ are both set weights; p₃∈[0,1] is a character region prediction probability; p₄∈[0,1] is a character boundary region prediction probability; T∈[0,1] is a set threshold;

neighborhood connection is performed on pixel points whose pixel values are 1 in the second binary image to obtain a plurality of connection units, and selecting a plurality of minimum rectangular bounding boxes of a plurality of connection units meeting the requirements of the character region as the character region.

The embodiments of the present disclosure further provide a text recognition apparatus, including:

a sample text dataset acquisition component, configured to acquire a sample text dataset, and preprocess each text image in the sample text dataset, wherein, the sample text dataset comprises a text position, positions of various characters in a text, and a character category;

a label image generation component, configured to generate a label image according to the text image which is preprocessed, wherein, the label image comprises a text region, a text boundary region, a character region, a character boundary region, and the character category, and perform diffusion annotation on the text boundary region and the character boundary region;

a text recognition model training component, configured to input the label image into a text recognition model for training, extract image features using a convolution layer, perform down-sampling using a pooling layer, restore an image resolution using up-sampling layer or a deconvolution layer, normalize an output probability for the last layer using a sigmoid layer to output multiple prediction maps with different scales, and optimize a loss function of the text recognition model using an optimizer to obtain a trained text recognition model;

a prediction map outputting component, configured to preprocess a text image to be recognized, input the text image which is preprocessed to be recognized into the trained text recognition model, and output, by the trained text recognition model, a clear-scale prediction map; and

a text sequence outputting component, configured to analyze the clear-scale prediction map to obtain a text sequence of the text image to be recognized.

The embodiments of the present disclosure further provides a terminal device, including a processor, a memory, and a computer program stored in the memory and configured to be executed by the processor, the processor executing the computer program to implement any one of the above method for recognizing texts.

### BRIEF DESCRIPTION OF THE DRAWINGS

FIG. 1 is a flow diagram of a method for recognizing text provided according to the present disclosure;

FIG. 2 is a schematic diagram of a network structure of a method for recognizing text provided according to the present disclosure;

FIG. 3 is a schematic structural diagram of a text recognition apparatus provided according to the present disclosure;

FIG. 4 is a schematic structural diagram of a terminal device provided according to the present disclosure;

FIG. 5 is a schematic structural diagram of three kinds of neighborhood connection provided according to the present disclosure.

### DETAILED DESCRIPTION OF THE EMBODIMENTS

The technical solutions in the embodiments of the present disclosure will be described clearly and completely below in combination with the accompanying drawings of the embodiments of the present disclosure. Apparently, the described embodiments are only part of the embodiments of the present disclosure, not all embodiments. Based on the embodiments in the present disclosure, all other embodiments obtained by those of ordinary skill in the art without doing creative work shall fall within the protection scope of the present disclosure.

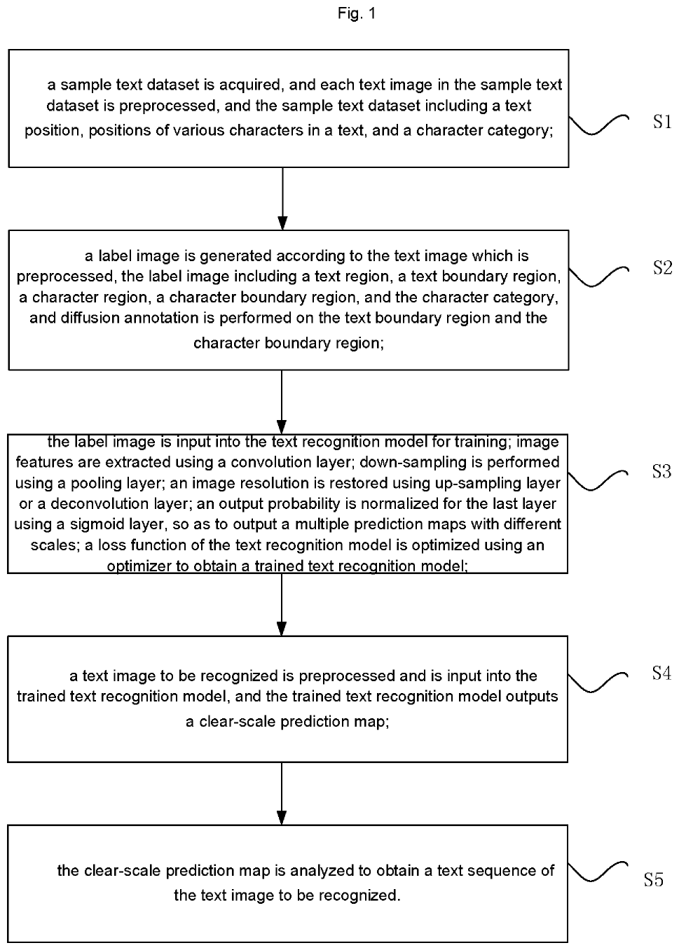

Referring to FIG. 1, FIG. 1 is a flow diagram of a method for recognizing text provided according to the present disclosure. The method for recognizing text includes:

S1, a sample text dataset is acquired, and each text image in the sample text dataset is preprocessed, and the sample text dataset including a text position, positions of various characters in a text, and a character category;

S2, a label image is generated according to the text image which is preprocessed, the label image including a text region, a text boundary region, a character region, a character boundary region, and the character category, and diffusion annotation is performed on the text boundary region and the character boundary region;

S3, the label image is input into the text recognition model for training; image features are extracted using a convolution layer; down-sampling is performed using a pooling layer; an image resolution is restored using up-sampling layer or a deconvolution layer; an output probability is normalized for the last layer using a sigmoid layer, so as to output a multiple prediction maps with different scales; a loss function of the text recognition model is optimized using an optimizer to obtain a trained text recognition model;

S4, a text image to be recognized is preprocessed and is input into the trained text recognition model, and the trained text recognition model outputs a clear-scale prediction map; and

S5, the clear-scale prediction map is analyzed to obtain a text sequence of the text image to be recognized.

Specifically, this embodiment acquires a sample text dataset. The sample text dataset includes a text position (x₀,y₀,w₀,h₀), positions (xₜ,yₜ,wₜ,hₜ) of various characters in a text, and a character category. (x,y) is an upper left point of a rectangular text box; w is a width of the rectangular box; h is a height of the rectangular box, i∈{1,2, . . . , N}; and N is the number of characters in the text sequence. Each text image in the sample text dataset is preprocessed, including size normalization and pixel value standardization.

The size normalization specifically includes: scaling all the text images in the sample text dataset to a uniform size. The text position of the scaled text image and the positions of the various character in the text are scaled as follows:

x=xS_{w}

y=ySₕ

w=wS_{w}

h=hSₕ;

and S_{w} and Sₕ are scaling factors in horizontal and vertical directions respectively.

Image interpolation methods in the image scaling process include the nearest neighbor method, the bilinear interpolation, the bicubic interpolation, etc.

In the pixel value standardization, there are three RGB channels for color images. A pixel value is set to be v=[vᵣ,v_{g},v_{b}], vᵣ∈[0,1], v_{b}∈[0,1], and v_{g}∈[0,1], and an average value of each channel is μ=[μᵣ, μ_{g}, μ_{b}], and a standard deviation is σ=[σᵣ, σ_{g}, ø_{b}]. A standardized formula is:

$${v}_{r}^{′} = \frac{{v}_{r} - {μ}_{r}}{{σ}_{r}}$$

$${v}_{g}^{′} = \frac{{v}_{g} - {μ}_{g}}{{σ}_{g}}$$

$${v}_{b}^{′} = \frac{{v}_{b} - {μ}_{b}}{{σ}_{b}} ;$$

and the average values and standard deviations of the every channel can use common values in an Image Net database. The average values of the various channels are [0.485, 0.456, 0.406], and the standard deviations of the various channels are [0.229, 0.224, 0.225]. In addition, other datasets can also be used to calculate the statistical average values and standard deviations.

A label image is generated according to the text image which is preprocessed. The label image includes a text region, a text boundary region, a character region, a character boundary region and a character category. The text region is an inner region of an annotated bounding box, marked as 1, and an outer region (a non-text region) is marked as 0. The character region is the inner region of the annotated bounding box, marked as 1, and the other non-character regions are marked as 0. Character category labels are marked according to the number of character categories. One label image represents a marking result of one character category. The text and character boundary regions are obtained from annotated positions. In order to accelerate the training convergence, diffusion annotation is performed on the boundary regions. The label image is input into the text recognition model for training; by taking a Fixed Pattern Noise (FPN) as a network structure, image features are extracted using a convolution layer; down-sampling is performed using a pooling layer; an image resolution is restored using up-sampling layer or a deconvolution layer; an output probability is normalized for the last layer using a sigmoid layer, so as to output a multiple prediction maps with different scales; a loss function of the text recognition model is optimized using an optimizer to obtain a trained text recognition model. After a text image to be recognized is preprocessed, i.e. by size normalization and pixel value standardization, the text image to be recognized is input into the trained text recognition model, and the trained text recognition model outputs a clear-scale prediction map. The clear-scale prediction map is analyzed to obtain a text sequence of the text image to be recognized.

This embodiment achieves end-to-end text recognition through a fully convolutional neural network; the process is simple; the computation amount is small; and the accuracy is high. At a training stage, the text region, the character region, the character category, the text boundary and the character boundary are combined for training, so that more context information can be combined to obtain a better recognition effect. At a prediction stage, only an image to be recognized is input into a network, and the network outputs a prediction probability map for analysis to obtain the text sequence.

In some embodiments, the diffusion annotation performed on the text boundary region and the character boundary region specifically includes:

m(x,y) is set as a boundary point. For any point p(x, y), there is a boundary point

$$q = {arg min}_{m} {‖ m - p ‖}_{2}$$

closest to point p, and an annotation formula is:

$$f ( p ) = \{ \begin{matrix}\begin{matrix}{v}_{max} , & {‖ p - q ‖}_{2} = 0 \\ 0 , & {‖ p - q ‖}_{2} > T\end{matrix} \\ {v}_{max} - \frac{{v}_{max} - {v}_{min}}{T} {‖ p - q ‖}_{2} , 0 < {‖ p - q ‖}_{2} \leq T\end{matrix} ;$$

and T is a distance threshold; vₘₐₓ and vₘᵢₙ represent set empirical values; a label value of a pixel point located in the center of the boundary is the vₘₐₓ; and a label value of a pixel point located around the boundary is between the vₘᵢₙ and the vₘₐₓ.

In some embodiments, the multiple prediction maps with different scales includes a clear-scale prediction map and a fuzzy-scale prediction map; and the clear-scale prediction map includes a text region, a text boundary region, a character region, a character boundary region and a character category, and the fuzzy-scale prediction map includes a text region, a text character region and a character category.

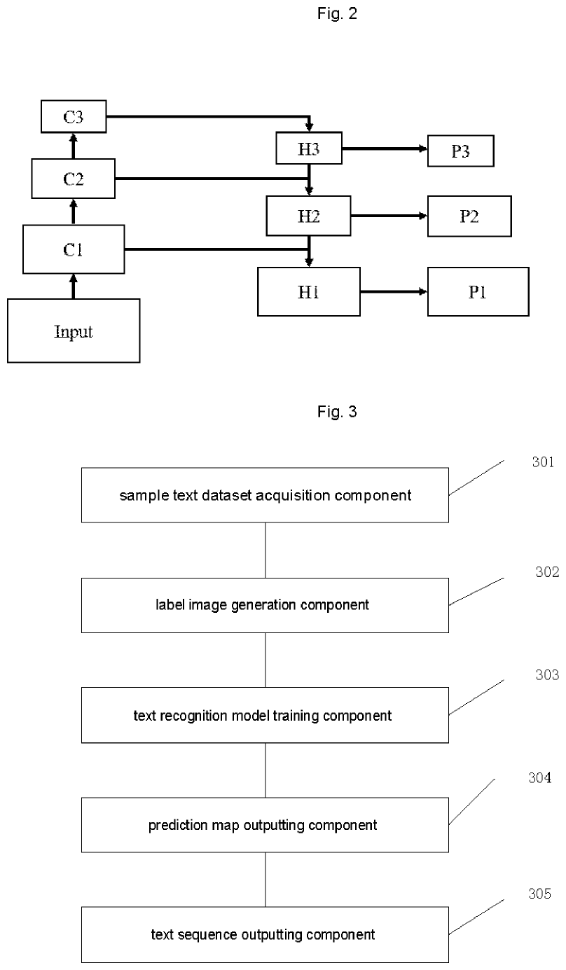

Specifically, referring to FIG. 2, FIG. 2 is a schematic diagram of a network structure of a method for recognizing text provided according to the present disclosure. Input refers to an input picture; C1, C2 and C3 are the characteristic maps obtained after convolution and down-sampling; H3, H2 and H1 are characteristic maps obtained after convolution and up-sampling; and P3, P2 and P1 are output prediction probability maps of different scales. The clear-scale prediction map (P1) includes a text region, a text boundary region, a character region, a character boundary region and a character category. The fuzzy-scale prediction maps (P2, P3) only predict text regions, character regions and character categories. The scales from P3 to P1 are from large to small; the image clarity is from fuzzy to clear; and the image resolution is from low to high. A larger scale indicates a fuzzier image, and a smaller scale indicates a clearer image.

In some embodiments, a loss function of the text recognition model includes a loss of the text region, a loss of the character region and a loss of the character category, and:

the loss of the text region includes loss of a text main region and loss of the text boundary region, that is:

L_{c}=λₚLₚ+λ_{pb}L_{pb};

and is total loss of the text region; Lₚ is cross entropy loss of the text main region; L_{pb} is cross entropy loss of the text boundary region; λₚ is the weight of the loss of the text main region, λ_{pb} is the weight of the loss of the text boundary region;

the loss of the character region includes loss of the character region and a loss of the character boundary region, that is:

L_{b}=λ_{ch}L_{ch}+λ_{chb}L_{chb};

and L_{b} is total loss of the character region; L_{ch} is cross entropy loss of the character main region; L_{chb} is cross entropy loss of the character boundary region; λ_{ch} is the weight of the loss of the character main region, λ_{chb} is the weight of the loss of the character boundary region;

the loss of the character category is: L_{c}=L_{cls};

the loss function of the text recognition model is L=λₐLₐ+λ_{b}L_{b}+λ_{c}L_{c}, and λa is the weight of the total loss of the text region, λb is the weight of the total loss of the character region, λc is the weight of the loss of the character category.

Specifically, this embodiment uses an Adam optimizer to optimize the loss function of the text recognition model. The loss function of the text recognition model includes a loss of the text region, a loss of the character region and a loss of the character category. A cross entropy loss function is used:

$${L}_{C E} = - \frac{1}{N} {\sum }_{i = 1}^{N} {\sum }_{k = 1}^{K} {w}_{k} {y}_{i , k} log {p}_{i , k} ;$$

and N is the number of voxel points; K is the number of categories; y_{i,k} represents a real label indicating that voxel point i is a kth category; p_{i,k} represents a prediction value indicating that voxel point i is the kth category; and wₖ represents a loss weight of the kth category.

The loss of the text region includes a loss of the text region and a loss of the text boundary region, that is:

L_{c}=λₚLₚ+λ_{pb}L_{pb};

and Lₐ is the total loss of the text region; Lₚ is the cross entropy loss of the text main region; L_{pb} is the cross entropy loss of the text boundary region; λₚ is the weight of the loss of the text main region, λ_{pb} is the weight of the loss of the text boundary region;

The loss of the character region includes the loss of the character region and the loss of the character boundary region, that is:

L_{b}=λ_{ch}L_{ch}+λ_{chb}L_{chb};

and L_{b} is the total loss of the character region; L_{ch} is the cross entropy loss of the character main region; L_{chb} is the cross entropy loss of the character boundary region; λ_{ch} is the weight of the loss of the character main region, λ_{chb} is the weight of the loss of the character boundary region;

The loss of the character category is: L_{c}=L_{cls};

The loss function of the text recognition model is L=λₐLₐ+λ_{b}L_{b}+λ_{c}L_{c}.

In some embodiments, step S5 that the clear-scale prediction map is analyzed to obtain a text sequence of the text image to be recognized specifically includes:

S501, a text box is analyzed according to a text region prediction map and a text boundary region prediction map to obtain the text region;

S502, a character box in the text region is analyzed according to a character region prediction map and a character boundary prediction map to obtain the character region;

S503, the character category with the highest probability in the character region is taken as a category of the pixel point, and the character category with the largest number of pixel points is counted as a final character category of the character box; and

S504, characters are connected according to the positions of the characters to obtain a text sequence of the text image to be recognized.

As some solutions, S501 that the text box is analyzed according to the text region prediction map and the text boundary region prediction map to obtain the text region specifically includes:

the text box is analyzed according to the text region prediction map and the text boundary region prediction map; pixel points that satisfy ω₁p₁+ω₂p₂>T are set to 1, and a first binary image is obtained, where ω₁ and ω₂ are both set weights; p₁∈[0,1] is a text region prediction probability; p₂∈[0,1] is a text boundary region prediction probability; T∈[0,1] is a set threshold;

neighborhood connection is performed on pixel points whose pixel values are 1 in the second binary image to obtain a plurality of connection units, and a plurality of minimum rectangular bounding boxes of a plurality of connection units meeting the requirements of the character region are selected as the character region.

Specifically, referring to FIG. 5, FIG. 5 is a schematic structural diagram of three kinds of neighborhood connection. As shown in FIG. 5, from left to right, there are 4 neighborhoods, diagonal neighborhoods and 8 neighborhoods. For the nine house grid with the pixel P as the center, the four pixels covered by a “plus sign” are called the four neighbors of the central pixel, which are recorded as N4 (P); The four pixels in the corner are diagonal neighbors, which are recorded as ND (P); All 8 surrounding pixels are called the 8 neighborhood of the center pixel, which is recorded as N8 (P).

As some solutions, step S502 that the character box in the text region is analyzed according to the character region prediction map and the character boundary region prediction map to obtain the character region specifically includes:

the character box in the text region is analyzed according to the character region prediction map and the character boundary region prediction map; pixel points that satisfy ω₃p₃+ω₄p₄>T are set to 1, and a second binary image is obtained, where ω₃ and ω₄ are both set weights; p₃∈p₃∈[0,1] is a character region prediction probability; p₄∈[0,1] is a character boundary region prediction probability; T∈[0,1] is a set threshold;

neighborhood connection is performed on pixel points whose pixel values are 1 in the second binary image to obtain a plurality of connection units, and a minimum rectangular bounding box of a plurality of connection bodies meeting the requirements of the character region is selected as the character region.

Specifically, the text box is analyzed according to the text region prediction map and the text boundary region prediction map; the pixel points that satisfy ω₁p₁+ω₂p₂>T are set to 1; and the first binary image is obtained, where ω₁ and ω₂ are both set weights, which can be any value. Generally, ω₁ can be set to a value within the range of [0, 1], and ω₂ is set to a value within the range of [−1, 0]; p₁∈[0,1] is the text region prediction probability; p₂∈[0,1] is the text boundary region prediction probability; T∈[0,1] is the set threshold; 4-neighborhood connection or 8-neighborhood connection is performed on the pixel points whose pixel values are 1 in the first binary image to obtain the plurality of connection units. The connection unit with the largest area is the largest connection body. Since the largest connection body is irregularly shaped, the minimum rectangular bounding box that can enclose the largest connection body is selected as the rectangular text region.

The character box in the text region is analyzed according to the character region prediction map and the character boundary region prediction map; pixel points that satisfy ω₃p₃+ω₄p₄>T are set to 1; and the second binary image is obtained, where ω₃ and ω₄ are both set weights, which may be any value. Generally, ω₁ can be set to a value within the range of [0, 1], and ω₂ is set to a value within the range of [−1, 0]; p₃∈[0,1] is the character region prediction probability; p₄∈[0,1] is the character boundary region prediction probability; and T∈[0,1] is the set threshold. Neighborhood connection is performed on the pixel points whose pixel values are 1 in the second binary image to obtain the plurality of connection units, and the minimum rectangular bounding box of a plurality of connection bodies meeting the requirements of the character region is selected as the character region. A rule for determining whether the requirements of the character region are met is determining whether the rectangular bounding box is the character region according to whether a length-width ratio and an area are within certain ranges. A rectangular bounding box needs to satisfy the following formulas at the same time before it is considered as a character region:

$$w h {r}_{min} < \frac{w}{h} < w h {r}_{max} ;$$

$${area}_{min} < wh < {area}_{max} ;$$

The character category with the highest probability in the character region is taken as a category of the pixel point; the character category with the largest number of pixel points is counted as a final character category of the character box. Pixel points on the clear-scale prediction map can be predicted to be multiple categories, such as a width W, a height H, and a category number C. A dimension of the prediction map is W×H×C. The character category with the highest probability is selected to output a map with the size of W×H. The values of the pixel points on the map are 1 to C.

Characters are connected according to the positions of the characters to obtain a text sequence of the text image to be recognized. For example, for a single-row license plate, characters are output from left to right according to a horizontal position of the character box and are connected to obtain a text sequence of a license plate number. For a double-row license plate, a row to which characters belongs is first determined according to whether the center of the character box is located at an upper half part or a lower half part; and the characters are then connected from left to right according to the horizontal position for each line, thus obtaining a text sequence in which two rows of character strings are used as a license plate number.

In this embodiment, a network skeleton structure can be ResNet, DenseNet, MobileNet, etc. The loss function can use Dice loss, FocalLoss, etc. The optimizer can use Adam, SGD, Adadelta, etc. A Gaussian heat map can be used for generating a region label, and a narrowed region label can be used. An image dilation method can be used for diffusion characteristics when a boundary label is generated. Before image preprocessing, data enhancement can be used for improving the generalization ability, including clipping, rotation, translation, scaling, noise adding, fuzzifying, brightness changing, contrast changing and other methods.

At the prediction stage of this embodiment, the accuracy can be improved by combining prior information of a license plate. For example, after character boxes of the license plate is acquired, it can be determined, according to the number and positions of the character boxes, whether the license plate an ordinary license plate, a new energy license plate, a double-row license plate, and the like. Then, if the number of possible categories of the character boxes at fixed positions is reduced, only the most appropriate prediction category is found in corresponding categories. For example, for an ordinary license plate, the first character is the province; the second character is a letter; and the following characters are numbers or letters. At the prediction stage, a license plate region can be extracted first, and a character category can then be predicted. After the license plate region is extracted, a character category probability is calculated for the license plate region only. Trained network parameters can be used, or another network, such as CRNN, can be used for recognizing the license plate. At the prediction stage, a character region can be extracted first, and a character category can then be predicted. After the character region is extracted, a neural network or a traditional machine learning classifier is used for predicting single characters.

Correspondingly, the present disclosure further provides a text recognition apparatus, which can implement all the processes of the method for recognizing text in the above embodiments.

Referring to FIG. 3, FIG. 3 is a schematic structural diagram of a text recognition apparatus provided according to the present disclosure. The text recognition apparatus includes:

a sample text dataset acquisition component 301, configured to acquire a sample text dataset, and preprocess each text image in the sample text dataset, the sample text dataset including a text position, positions of various characters in a text, and a character category;

a label image generation component 302, configured to generate a label image according to the text image which is preprocessed, the label image including a text region, a text boundary region, a character region, a character boundary region, and the character category, and perform diffusion annotation on the text boundary region and the character boundary region;

a text recognition model training component 303, configured to input the label image into the text recognition model for training, extract image features using a convolution layer, perform down-sampling using a pooling layer, restore an image resolution using up-sampling layer or a deconvolution layer, normalize an output probability for the last layer using a sigmoid layer to output a multiple prediction maps with different scales, and optimize a loss function of the text recognition model using an optimizer to obtain a trained text recognition model;

a prediction map outputting component 304, configured to preprocess a text image to be recognized, input the text image which is preprocessed to be recognized into the trained text recognition model, and output, by the trained text recognition model, a clear-scale prediction map; and

a text sequence outputting component 305, configured to analyze the clear-scale prediction map to obtain a text sequence of the text image to be recognized.

Preferably, the diffusion annotation performed on the text boundary region and the character boundary region specifically includes:

m(x, y) is set as a boundary point. For any point p(x, y), there is a boundary point

$$q = {arg min}_{m} {‖ m - p ‖}_{2}$$

closest to point p, and an annotation formula is:

$$f ( p ) = \{ \begin{matrix}\begin{matrix}{v}_{max} , & {‖ p - q ‖}_{2} = 0 \\ 0 , & {‖ p - q ‖}_{2} > T\end{matrix} \\ {v}_{max} - \frac{{v}_{max} - {v}_{min}}{T} {‖ p - q ‖}_{2} , 0 < {‖ p - q ‖}_{2} \leq T\end{matrix} ;$$

and T is a distance threshold; vₘₐₓ and vₘᵢₙ represent set empirical values; a label value of a pixel point located in the center of the boundary is vₘₐₓ; and a label value of a pixel point located around the boundary is between vₘᵢₙ and vₘₐₓ.

Preferably, the multiple prediction maps with different scales includes a clear-scale prediction map and a fuzzy-scale prediction map; and the clear-scale prediction map includes a text region, a text boundary region, a character region, a character boundary region and a character category, and the fuzzy-scale prediction map includes a text region, a text character region and a character category.

Preferably, the loss function of the text recognition model includes a loss of the text region, a loss of the character region and a loss of the character category.

The loss of the text region includes a loss of the text region and a loss of the text boundary region, that is:

Lₐ=λₚLₚ+λ_{pb}L_{pb};

and Lₐ is the total loss of the text region; Lₚ is the cross entropy loss of the text main region; L_{pb} is the cross entropy loss of the text boundary region; λₚ and λ_{pb} are respectively weights of the losses of the text main region and the loss of text boundary region.

The loss of the character region includes the loss of the character region and the loss of the character boundary region, that is:

L_{b}=λ_{ch}L_{ch}+λ_{chb}L_{chb};

and L_{b} is the total loss of the character region; L_{ch} is the cross entropy loss of the character main region; L_{chb} is the cross entropy loss of the character boundary region; λ_{ch} and λ_{chb} are respectively weights of the losses of the character main region and the character boundary region.

The loss of the character category is: L_{c}=L_{cls};

The loss function of the text recognition model is L=λₐLₐ+λ_{b}L_{b}+λ_{c}L_{c}.

Preferably, the text sequence outputting component 305 is specifically configured to:

analyze a text box according to a text region prediction map and a text boundary region prediction map to obtain the text region;

analyze a character box in the text region according to a character region prediction map and a character boundary prediction map to obtain the character region;

take the character category with the highest probability in the character region as a category of the pixel point, and count the character category with the largest number of pixel points as a final character category of the character box; and

connect characters according to the positions of the characters to obtain a text sequence of the text image to be recognized.

Preferably, the action that a text box is analyzed according to a text region prediction map and a text boundary region prediction map to obtain the text region specifically includes:

the text box is analyzed according to the text region prediction map and the text boundary region prediction map; pixel points that satisfy ω₁p₁+ω₂p₂>T are set to 1, and a first binary image is obtained, where ω₁ and ω₂ are both set weights; p₁∈[0,1] is a text region prediction probability; p₂∈[0,1] is a text boundary region prediction probability; T∈[0,1] is a set threshold;

neighborhood connection is performed on the pixel points whose pixel values are 1 in the first binary image to obtain a plurality of connection units, and a minimum rectangular bounding box of the connection unit with a largest area is selected as the text region.

Preferably, the action that a character box in the text region is analyzed according to a character region prediction map and a character boundary region prediction map to obtain the character region specifically includes:

the character box in the text region is analyzed according to the character region prediction map and the character boundary region prediction map; pixel points that satisfy ω₃p₃+ω₄p₄>T are set to 1, and a second binary image is obtained, where ω₃ and ω₄ are both set weights; p₃∈[0,1] is a character region prediction probability; p₄∈[0,1] is a character boundary region prediction probability; T∈[0,1] is a set threshold;

neighborhood connection is performed on pixel points whose pixel values are 1 in the second binary image to obtain a plurality of connection units, and a minimum rectangular bounding box of a plurality of connection bodies meeting the requirements of the character region is selected as the character region.

In specific implementation, the working principle, the control process and the achieved technical effects of the text recognition apparatus provided according to the embodiment of the present disclosure are correspondingly the same as those of the method for recognizing text in the above embodiment, so descriptions thereof are omitted here.

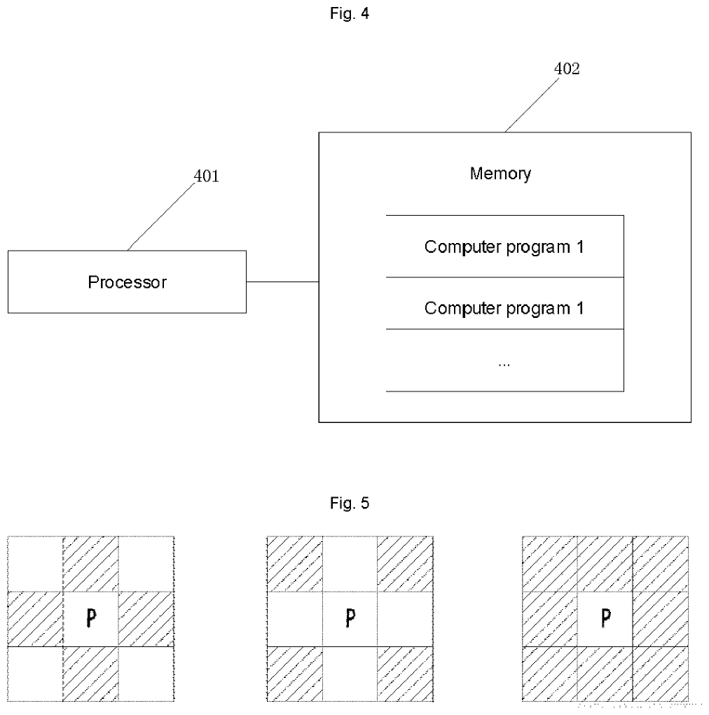

Referring to FIG. 4, FIG. 4 is a schematic structural diagram of a terminal device provided according to the present disclosure. The terminal device includes a processor 401, a memory 402, and a computer program stored in the memory 402 and configured to be executed by the processor 401, the processor 401 executing the computer program to implement the method for recognizing text of any one of the above embodiments.

Preferably, the computer program may be divided into one or more components/units (such as computer program 1, computer program 2, . . . ). The one or more components/units are stored in the memory 402 and are executed by the processor 401 to complete the present disclosure. The one or more components/units may be a series of computer program instruction segments capable of completing specific functions. The instruction segments are used for describing the execution process of the computer program in the terminal device.

The processor 401 can be a central processing unit (CPU), other general-purpose processors, digital signal processors (DSPs), application specific integrated circuits (ASICs), field-programmable gate arrays (FPGAs) or other programmable logic devices, discrete gates or transistor logic devices, discrete hardware components, and the like. The general processor can be a microprocessor. Or, the processor 401 can also be any conventional processor. The processor 401 is a control center of the terminal device, and is connected to various portions of the terminal device by various interfaces and lines.

The memory 402 mainly includes a program storage region and a data storage region. The program storage region can store an operating system, an application program required by at least one function, and the like, and the data storage region can store relevant data and the like. In addition, the memory 402 can be a high-speed random access memory or a nonvolatile memory, such as a plug-in hard disk, a smart media card (SMC), a secure digital (SD) card, a flash card, and the like, or the memory 402 can also be other volatile solid-state storage devices.

It should be noted that the above terminal device can include, but is not limited to, a processor and a memory. Those skilled in the art can understand that the schematic structural diagram of FIG. 4 is only an example of the above terminal device, and does not constitute a limitation to the above terminal device. It can include more or fewer components than shown in the figure, or combinations of some components, or different components.

An embodiment of the present disclosure further provides a computer-readable storage medium, including a stored computer program, the computer program, when running, controlling a device with the computer-readable storage medium to implement the method for recognizing text of any of the above embodiments.

The embodiments of the present disclosure provide a method for recognizing text and apparatus, a terminal device and a storage medium. End-to-end text recognition is achieved through a fully convolutional neural network; the process is simple; the computation amount is small; and the accuracy is high. At a training stage, the text region, the character region, the character category, the text boundary and the character boundary are combined for training, so that more context information can be combined to obtain a better recognition effect. At a prediction stage, only an image to be recognized is input into a network, and the network outputs a prediction probability map for analysis to obtain the text sequence.

It should be noted that the system embodiments described above are only illustrative, and the units described as separate components may or may not be physically separated, and the components displayed as units may or may not be physical units, that is, they may be located in one place, or may be distributed to multiple network units. Some or all of the components may be selected according to actual needs to achieve the objectives of the solutions of the embodiments. In addition, in the drawings of the system embodiments provided by the present disclosure, the connection relationships between the components indicate that they have communication connections, which can be specifically implemented as one or more communication buses or signal lines. Those of ordinary skill in the art can understand and implement it without creative effort.

The above is only the preferred embodiment of the present disclosure. It should be noted that those of ordinary skill in the art can further make several improvements and retouches without departing from the principles of the present disclosure. These improvements and retouches shall all fall within the protection scope of the present disclosure.

What is claimed is:

1. A method for recognizing text, comprising:
acquiring a sample text dataset, and preprocessing each text image in the sample text dataset, wherein, the sample text dataset comprises a text position, position of every character in a text, and a character category;
generating a label image according to the text image which is preprocessed, wherein, the label image comprises a text region, a text boundary region, a character region, a character boundary region, and the character category, and performing diffusion annotation on the text boundary region and the character boundary region;
inputting the label image into a text recognition model for training, extracting image features using a convolution layer, performing down-sampling using a pooling layer, restoring an image resolution using up-sampling layer or a deconvolution layer, normalizing an output probability for the last layer using a sigmoid layer to output multiple prediction maps with different scales, and optimizing a loss function of the text recognition model using an optimizer to obtain a trained text recognition model;
preprocessing a text image to be recognized, inputting the text image to be recognized which is preprocessed into the trained text recognition model, and outputting, by the trained text recognition model, a clear-scale prediction map; and
analyzing the clear-scale prediction map to obtain a text sequence of the text image to be recognized.

2. The method for recognizing text according to claim 1, wherein performing diffusion annotation on the text boundary region and the character boundary region specifically comprises:
setting m(x, y) as a boundary point, wherein for any point p(x, y), there is a boundary point
$$q = {arg min}_{m} {‖ m - p ‖}_{2}$$
closest to point p, and an annotation formula is:
$$f ( p ) = \{ \begin{matrix}\begin{matrix}{v}_{max} , & {‖ p - q ‖}_{2} = 0 \\ 0 , & {‖ p - q ‖}_{2} > T\end{matrix} \\ {v}_{max} - \frac{{v}_{max} - {v}_{min}}{T} {‖ p - q ‖}_{2} , 0 < {‖ p - q ‖}_{2} \leq T\end{matrix} ;$$
wherein T is a distance threshold; vₘₐₓ and vₘᵢₙ represent set empirical values; a label value of a pixel point located in the center of the boundary is the vₘₐₓ; and a label value of a pixel point located around the boundary is between the vₘᵢₙ and the vₘₐₓ.

3. The method for recognizing text according to claim 1, wherein the multiple prediction maps with different scales comprise a clear-scale prediction map and a fuzzy-scale prediction map; the clear-scale prediction map comprises a text region, a text boundary region, a character region, a character boundary region and a character category, and the fuzzy-scale prediction map comprises a text region, a text character region and a character category.

4. The method for recognizing text according to claim 1, wherein the loss function of the text recognition model comprises a loss of the text region, a loss of the character region and a loss of the character category, wherein
the loss of the text region comprises loss of a text main region and loss of the text boundary region, that is:
Lₐ=λₚLₚ+λ_{pb}L_{pb};
wherein Lₐ is total loss of the text region; Lₚ is cross entropy loss of the text main region; L_{pb} is cross entropy loss of the text boundary region; λₚ is the weight of the loss of the text main region, λ_{pb} is the weight of the loss of the text boundary region;
the loss of the character region comprises loss of a character main region and loss of the character boundary region, that is:
L_{b}=λ_{ch}L_{ch}+λ_{chb}L_{chb};
Wherein L_{b} is total loss of the character region; L_{ch} is cross entropy loss of the character main region; L_{chb} is cross entropy loss of the character boundary region; λ_{ch} is the weight of the loss of the character main region, λ_{chb} is the weight of the loss of the character boundary region;
the loss of the character category is: L_{c}=L_{cls};
the loss function of the text recognition model is L=λₐLₐ+λ_{b}L_{b}+λ_{c}L_{c}, wherein λₐ is the weight of the total loss of the text region, λ_{b} is the weight of the total loss of the character region, λ_{c} is the weight of the loss of the character category.

5. The method for recognizing text according to claim 3, wherein analyzing the clear-scale prediction map to obtain the text sequence of the text image to be recognized specifically comprises:
analyzing a text box according to a text region prediction map and a text boundary region prediction map to obtain the text region;
analyzing a character box in the text region according to a character region prediction map and a character boundary prediction map to obtain the character region;
taking the character category with the highest probability in the character region as a category of a pixel point, and counting the character category with the largest number of pixel points as a final character category of the character box; and
connecting characters according to the positions of the characters to obtain a text sequence of the text image to be recognized.

6. The method for recognizing text according to claim 5, wherein analyzing the text box according to the text region prediction map and the text boundary region prediction map to obtain the text region specifically comprises:
analyzing the text box according to the text region prediction map and the text boundary region prediction map, setting pixel points that satisfy ω₁p₁+ω₂p₂>T to 1, and obtaining a first binary image, where ω₁ and ω₂ are both set weights; p₁∈[0,1] is a text region prediction probability; p₂∈[0,1] is a text boundary region prediction probability; T∈[0,1] is a set threshold;
performing neighborhood connection on the pixel points whose pixel values are 1 in the first binary image to obtain a plurality of connection units, and selecting a minimum bounding rectangle of the connection unit with the largest area as the text region.

7. The method for recognizing text according to claim 5, wherein analyzing the character box in the text region according to the character region prediction map and the character boundary region prediction map to obtain the character region specifically comprises:
analyzing the character box in the text region according to the character region prediction map and the character boundary region prediction map, setting pixel points that satisfy ω₃p₃+ω₄p₄>T to 1, and obtaining a second binary image, where ω₃ and ω₄ are both set weights; p₃∈[0,1] is a character region prediction probability; p₄∈[0,1] is a character boundary region prediction probability; T∈[0,1] is a set threshold;
neighborhood connection is performed on pixel points whose pixel values are 1 in the second binary image to obtain a plurality of connection units, and a plurality of minimum rectangular bounding boxes of a plurality of connection units meeting the requirements of the character region are selected as the character region.

8. A text recognition apparatus, comprising:
a sample text dataset acquisition component, configured to acquire a sample text dataset, and preprocess each text image in the sample text dataset, wherein, the sample text dataset comprises a text position, positions of various characters in a text, and a character category;
a label image generation component, configured to generate a label image according to the text image which is preprocessed, wherein, the label image comprises a text region, a text boundary region, a character region, a character boundary region, and the character category, and perform diffusion annotation on the text boundary region and the character boundary region;
a text recognition model training component, configured to input the label image into a text recognition model for training, extract image features using a convolution layer, perform down-sampling using a pooling layer, restore an image resolution using up-sampling layer or a deconvolution layer, normalize an output probability for the last layer using a sigmoid layer to output multiple prediction maps with different scales, and optimize a loss function of the text recognition model using an optimizer to obtain a trained text recognition model;
a prediction map outputting component, configured to preprocess a text image to be recognized, input the text image which is preprocessed to be recognized into the trained text recognition model, and output, by the trained text recognition model, a clear-scale prediction map; and
a text sequence outputting component, configured to analyze the clear-scale prediction map to obtain a text sequence of the text image to be recognized.

9. The text recognition apparatus according to claim 8, wherein the sample text dataset acquisition component, configured to set m(x, y) as a boundary point, wherein for any point p(x, y), there is a boundary point
$$q = {arg min}_{m} {‖ m - p ‖}_{2}$$
closest to point p, and an annotation formula is:
$$f ( p ) = \{ \begin{matrix}\begin{matrix}{v}_{max} , & {‖ p - q ‖}_{2} = 0 \\ 0 , & {‖ p - q ‖}_{2} > T\end{matrix} \\ {v}_{max} - \frac{{v}_{max} - {v}_{min}}{T} {‖ p - q ‖}_{2} , 0 < {‖ p - q ‖}_{2} \leq T\end{matrix} ;$$
wherein T is a distance threshold; vₘₐₓ and vₘᵢₙ represent set empirical values; a label value of a pixel point located in the center of the boundary is the vₘₐₓ; and a label value of a pixel point located around the boundary is between the vₘᵢₙ and the vₘₐₓ.

10. The text recognition apparatus according to claim 8, wherein the multiple prediction maps with different scales comprise a clear-scale prediction map and a fuzzy-scale prediction map; the clear-scale prediction map comprises a text region, a text boundary region, a character region, a character boundary region and a character category, and the fuzzy-scale prediction map comprises a text region, a text character region and a character category.

11. The text recognition apparatus according to claim 8, wherein the loss function of the text recognition model comprises a loss of the text region, a loss of the character region and a loss of the character category, wherein
the loss of the text region comprises loss of a text main region and loss of the text boundary region, that is:
Lₐ=λₚLₚ+λ_{pb}L_{pb};
wherein Lₐ is total loss of the text region; Lₚ is cross entropy loss of the text main region; L_{pb} is cross entropy loss of the text boundary region; λₚ is the weight of the loss of the text main region, λ_{pb} is the weight of the loss of the text boundary region;
the loss of the character region comprises loss of a character main region and loss of the character boundary region, that is:
L_{b}=λ_{ch}L_{ch}+λ_{chb}L_{chb};
wherein L_{b} is total loss of the character region; L_{ch} is cross entropy loss of the character main region; L_{chb} is cross entropy loss of the character boundary region; λ_{ch} is the weight of the loss of the character main region, λ_{chb} is the weight of the loss of the character boundary region;
the loss of the character category is: L_{c}=L_{cls};
the loss function of the text recognition model is L=λₐLₐ+λ_{b}L_{b}+λ_{c}L_{c}, where is the weight of the total loss of the text region, λ_{b} is the weight of the total loss of the character region, λ_{c} is the weight of the loss of the character category.

12. The text recognition apparatus according to claim 10, the text sequence outputting component, configured to
analyze a text box according to a text region prediction map and a text boundary region prediction map to obtain the text region;
analyze a character box in the text region according to a character region prediction map and a character boundary prediction map to obtain the character region;
take the character category with the highest probability in the character region as a category of a pixel point, and counting the character category with the largest number of pixel points as a final character category of the character box; and
connect characters according to the positions of the characters to obtain a text sequence of the text image to be recognized.

13. A terminal device, comprising a processor, a memory, and a computer program stored in the memory and configured to be executed by the processor, the processor executing the computer program to implement the method for recognizing text, wherein the method comprises:
acquiring a sample text dataset, and preprocessing each text image in the sample text dataset, wherein, the sample text dataset comprises a text position, position of every character in a text, and a character category;
generating a label image according to the text image which is preprocessed, wherein, the label image comprises a text region, a text boundary region, a character region, a character boundary region, and the character category, and performing diffusion annotation on the text boundary region and the character boundary region;
inputting the label image into a text recognition model for training, extracting image features using a convolution layer, performing down-sampling using a pooling layer, restoring an image resolution using up-sampling layer or a deconvolution layer, normalizing an output probability for the last layer using a sigmoid layer to output multiple prediction maps with different scales, and optimizing a loss function of the text recognition model using an optimizer to obtain a trained text recognition model;
preprocessing a text image to be recognized, inputting the text image to be recognized which is preprocessed into the trained text recognition model, and outputting, by the trained text recognition model, a clear-scale prediction map; and
analyzing the clear-scale prediction map to obtain a text sequence of the text image to be recognized.

14. The terminal device according to claim 13, wherein performing diffusion annotation on the text boundary region and the character boundary region specifically comprises:
setting m(x, y) as a boundary point, wherein for any point p(x, y), there is a boundary point
$$q = {arg min}_{m} {‖ m - p ‖}_{2}$$
closest to point p, and an annotation formula is:
$$f ( p ) = \{ \begin{matrix}\begin{matrix}{v}_{max} , & {‖ p - q ‖}_{2} = 0 \\ 0 , & {‖ p - q ‖}_{2} > T\end{matrix} \\ {v}_{max} - \frac{{v}_{max} - {v}_{min}}{T} {‖ p - q ‖}_{2} , 0 < {‖ p - q ‖}_{2} \leq T\end{matrix} ;$$
wherein T is a distance threshold; vₘₐₓ and vₘᵢₙ represent set empirical values; a label value of a pixel point located in the center of the boundary is the vₘₐₓ; and a label value of a pixel point located around the boundary is between the vₘᵢₙ and the vₘₐₓ.

15. The terminal device according to claim 13, wherein the multiple prediction maps with different scales comprise a clear-scale prediction map and a fuzzy-scale prediction map; the clear-scale prediction map comprises a text region, a text boundary region, a character region, a character boundary region and a character category, and the fuzzy-scale prediction map comprises a text region, a text character region and a character category.

16. The terminal device according to claim 13, wherein the loss function of the text recognition model comprises a loss of the text region, a loss of the character region and a loss of the character category, wherein
the loss of the text region comprises loss of a text main region and loss of the text boundary region, that is:
Lₐ=λₚLₚ+λ_{pb}L_{pb};
wherein Lₐ is total loss of the text region; Lₚ is cross entropy loss of the text main region; Lₚₕ is cross entropy loss of the text boundary region; λₚ is the weight of the loss of the text main region, λ_{pb} is the weight of the loss of the text boundary region;
the loss of the character region comprises loss of a character main region and loss of the character boundary region, that is:
L_{b}=λ_{ch}L_{ch}+λ_{chb}L_{chb};
Wherein L_{b} is total loss of the character region; L_{ch} is cross entropy loss of the character main region; L_{chb} is cross entropy loss of the character boundary region; λ_{ch} is the weight of the loss of the character main region, λ_{chb} is the weight of the loss of the character boundary region;
the loss of the character category is: L_{c}=L_{cls};
the loss function of the text recognition model is L=λₐLₐ+λ_{b}L_{b}+λ_{c}L_{c}, wherein λₐ is the weight of the total loss of the text region, λ_{b} is the weight of the total loss of the character region, λ_{c} is the weight of the loss of the character category.

17. The terminal device according to claim 15, wherein analyzing the clear-scale prediction map to obtain the text sequence of the text image to be recognized specifically comprises:
analyzing a text box according to a text region prediction map and a text boundary region prediction map to obtain the text region;
analyzing a character box in the text region according to a character region prediction map and a character boundary prediction map to obtain the character region;
taking the character category with the highest probability in the character region as a category of a pixel point, and counting the character category with the largest number of pixel points as a final character category of the character box; and
connecting characters according to the positions of the characters to obtain a text sequence of the text image to be recognized.

18. The terminal device according to claim 17, wherein analyzing the text box according to the text region prediction map and the text boundary region prediction map to obtain the text region specifically comprises:
analyzing the text box according to the text region prediction map and the text boundary region prediction map, setting pixel points that satisfy ω₁p₁+ω₂p₂>T to 1, and obtaining a first binary image, where ω₁ and ω₂ are both set weights; p₁∈[0,1] is a text region prediction probability; p₂∈[0,1] is a text boundary region prediction probability; T∈[0,1] is a set threshold;
performing neighborhood connection on the pixel points whose pixel values are 1 in the first binary image to obtain a plurality of connection units, and selecting a minimum bounding rectangle of the connection unit with the largest area as the text region.

19. The terminal device according to claim 17, wherein analyzing the character box in the text region according to the character region prediction map and the character boundary region prediction map to obtain the character region specifically comprises:
analyzing the character box in the text region according to the character region prediction map and the character boundary region prediction map, setting pixel points that satisfy ω₃p₃+ω₄p₄>T to 1, and obtaining a second binary image, where ω₃ and ω₄ are both set weights; p₃∈[0,1] is a character region prediction probability; p₄∈[0,1] is a character boundary region prediction probability; T∈[0,1] is a set threshold;
neighborhood connection is performed on pixel points whose pixel values are 1 in the second binary image to obtain a plurality of connection units, and a plurality of minimum rectangular bounding boxes of a plurality of connection units meeting the requirements of the character region are selected as the character region.
